(19) United States
(12) Patent Application Publication
(10) Pub. No.: US 2012/0241247 A1
(43) Pub. Date: Sep. 27, 2012

(54) Audio Enhancing Apparatus for Smart Tablets

(76) Inventor: Dong Il Choe, (US)

(21) Appl. No.: 13/422,066

(22) Filed: Mar. 16, 2012

Related U.S. Application Data
(60) Provisional application No. 61/465,838, filed on Mar. 25, 2011.

(51) Int. Cl. G10K 11/20; B29C 45/00; B29C 37/02

(52) U.S. Cl. 181/191; 264/138; 264/153; 264/328.1

(57) ABSTRACT

An Audio enhancer apparatus for smart phones and smart tablets that is portable, attachable and detachable to an audio producing device providing a richer, louder and pseudo stereo listening experience without the need of electricity or any other types of power source.

I claimed the priority of the provisional application #61/465838 which was filed on Mar. 25, 2011.

### FIELD OF INVENTION

Present invention relates generally to the field of audio magnifying and enhancing equipments such as non-power sourced megaphone and stethoscope.

### BACKGROUND OF INVENTION

In today's ever so popular world of portable and stationary electronic devices, there are many devices that generates monster of wattage to produce an audio that can deafen an ear, but there are many that lack such power and produces poor acoustic output. Main reason for such poor acoustic output is result of constant downsizing of a device for portability, limited power output from an underpowered battery source and the minuscule size of its built-in speakers. In addition, once the audio output leaves the device's speaker, it disperses and scatters since there is no confinement or containment, it mainly sounds flat and loses other important acoustic characteristics such as crispiness and loudness. Most of the portable electronic audio producing device such as smart phones, and smart tablets are at the focal point of this present invention. These devices are small, flat in dimensional depth, with underpowered batteries and minuscule sized speakers.

Present invention is an apparatus that will improve audio quality and magnify audio output without the need of any power source. Additionally, the enhanced audio output is directed towards the listener for optimal listening experience.

### SUMMARY OF INVENTION

Purpose of the present invention is to create small, simple and light weight portable audio enhancing apparatus for the various audio producing devices such as smart phones and smart tablets in the current and future market. Present invention utilizes “Concentrated Audio Flow Technology” or “CAFT” process to produce such audio enhancement for the smart phones and smart tablets.

The “CAFT” process concept was adopted using shotgun shell impact behavior. When a shot is fired and tens of tiny little pellets hit a wooden target, it leaves bunch of small holes and target remains intact most of the time because pellets are scattered and loses much of its impact power. But when a solid slug shell is fired on a same target, it blasts the wooden target to pieces because slug is equivalent to tens of tiny little pellets concentrated into one solid piece. Sound waves behave similarly for smart devices. Without concentration, they are scattered thus, resulting in poor audio overall quality but once concentrated, it delivers magnified and much improved audio quality.

Main embodiment of the present invention is comprised of 3 frontal ports, 3 rear ports and 1 audio reflector. 3 frontal ports consist of 1-main audio inceptor port for audio admission and containment, 2-secondary intake port is for cosmetic purpose. Rear ports consist of 1-main outtake port for audio emission and 2-secondary exit ports also for cosmetic purpose.

Present invention's Intake port assembly which consist of main audio inceptor port contains and concentrates the admitted audio waves from an attached external audio producing device. Once entered, becomes contained and concentrated audio wave is transferred to the outtake port assembly where the audio reflector, redirects the contained and concentrated audio wave from the intake port assembly towards the listener. Contained and concentrated audio output emitted through the present invention delivers much improved audio quality that is richer, louder and pseudo-stereo audio to the owner or the listener of the external audio producing device.

In addition, since the present invention produces richer and louder audio output, less volume level can be used on the external audio producing device and achieve higher level volume output which results in less power consumption and more battery life for the owner of the device.

Without the CAFT process of audio waves through such apparatus, original audio waves from the audio producing device are scattered, thus resulting in poor overall audio quality.

Larger or smaller scale of the present invention and alteration of its design can be exercised to enhance the audio quality of any audio producing device with speakers

Present invention's main embodiment can produce similar audio enhancement without having all the ports described in earlier paragraph. To simplify design process and size, present invention's main embodiment can have only one open port or space to receive and emit sound enhancement from an audio producing device. In addition, present invention's main embodiment does not require having an audio reflector to redirect sound. Emitted sound from the present invention's main embodiment can be redirected by the outtake port assembly wall towards the listener but degradation in sound enhancement may be present.

### BRIEF DESCRIPTION OF THE DRAWINGS

In the drawings:

FIG. 1 is perspective view of the audio enhancing apparatus for the present invention for iPad1 and Samsung Galaxy Tablet.

FIG. 2 is perspective view of the audio reflector of the present invention.

FIG. 3 is the operational side view of the audio enhancing apparatus for the present invention illustrating “CAFT” process.

FIG. 4 is the frontal view of the audio enhancing apparatus of the present invention.

FIG. 5 is the rear view of the audio enhancing apparatus of the present invention.

FIG. 6 is the perspective view of the audio enhancing apparatus of the present invention after modifications for iPad 2.

FIG. 6.1 is the exploded view of the right-side port external wall of the present invention after modification for iPad 2.

FIG. 7 is the perspective view of the audio enhancing apparatus attached to the iPad 1 or iPad 2.

FIG. 8 is the perspective view of the audio enhancing apparatus attached to Samsung Galaxy Tablet.

FIG. 9 is the perspective view of the simplified version of audio enhancer apparatus attached to iPad 1 or iPad 2.

### DETAILED DESCRIPTION OF THE PREFERRED EMBODIMENTS

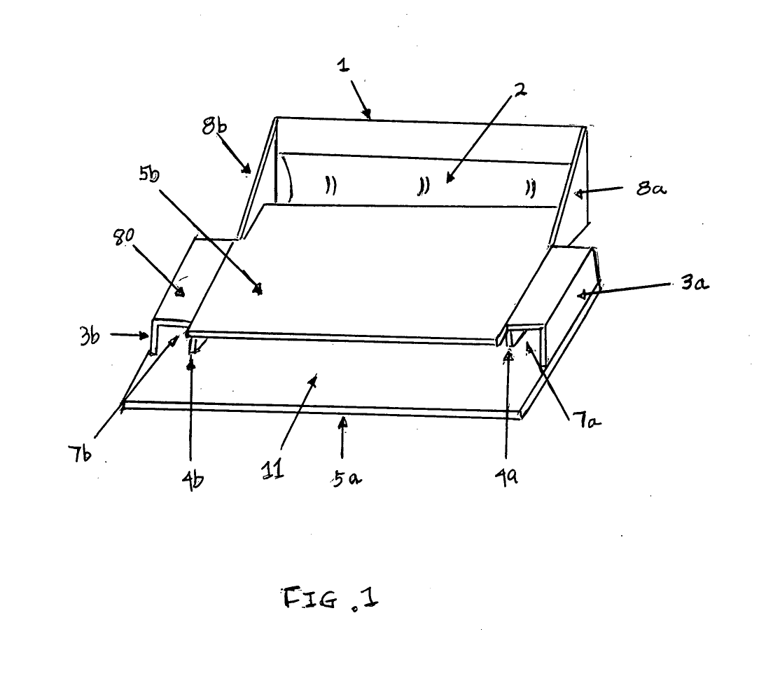

The present invention's embodiment shown in FIG. 1 is an audio enhancing apparatus comprising of flat covers and square and rectangle ports and one audio reflector. Intake port assembly 5a, 5b, 4a, 4b, and main audio inceptor port 11, are the main location for incepting audio output from external audio producing device. Intake assembly port compartmental walls 4a, 4b, function as a divider for the main audio intake port 11 and secondary intake port 7a, 7b.

In more detail, still referring to invention of FIG. 1, once the audio output from another device is admitted to the intake port assembly 5a, 5b, 4a, 4b, and main audio inceptor 11, audio is contained and concentrated, it initiates CAFT process. Than the CAFT process inside the intake port assembly is transferred to the outtake port assembly 8a, 8b, 1. Whereas, the outtake port assembly walls 8a, 8b, 1, contains the transferred CAFT processed audio from further scattering. Than CAFT processed audio output is redirected upwards by the audio reflector 2. Thus through the process of containment, concentration, redirection of the admitted audio input through the present invention, richer, crispier, louder and pseudo-stereo audio output is experienced by the listener.

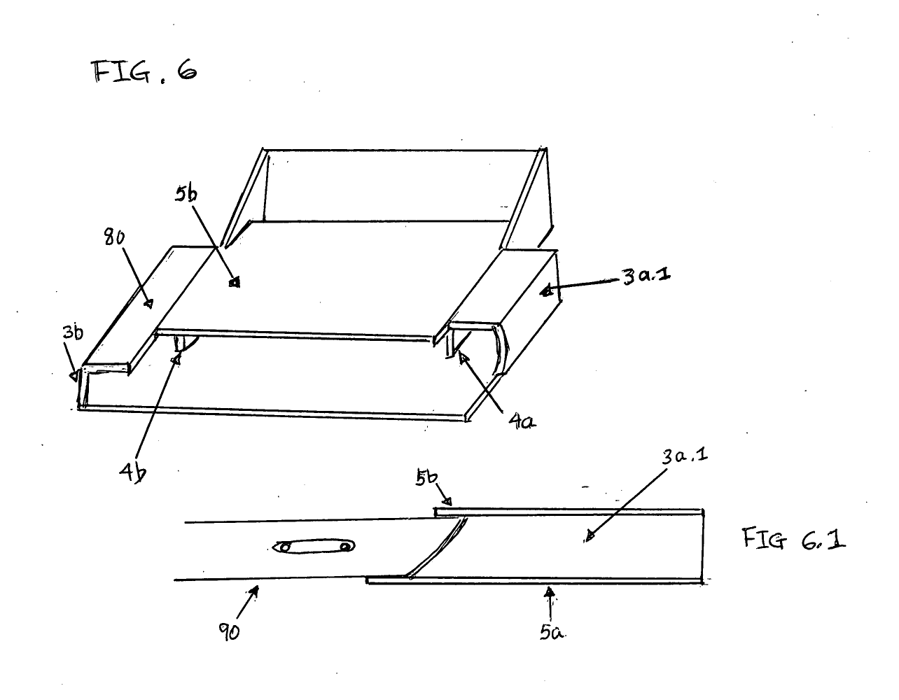

Dimensional detail of invention shown in FIG. 1 and FIG. 6 may be sized from 1 to 14 inches wide from side to side and length of the entire audio enhancing apparatus may be sized from 1 to 14 inches from front to back. Depth of the audio enhancing apparatus can be about 0.125 to about 14 inches.

Construction detail of invention shown in FIG. 1 and FIG. 6 are entirely made from using polyurethane, ceramic and sheet metal for best test results. Entire apparatus was also manufactured from using 1/16″ thick polyurethane sheet but thicker polyurethane sheet can be used for overall strength and durability of the present invention.

Prototype audio enhancing apparatus was tested on Apple iPad, iPad2 and iPhone4, which all of its speakers were located on the side surface. The prototype audio enhancing apparatus has abilities to latch or fitted on the respective corner, where speaker of the device is located for stability of the audio enhancing apparatus. No adapters were needed. For iPad2, left secondary intake port cover 80, left secondary intake external wall 3b and right secondary intake external wall 3a, needed slight cosmetic modification to accommodate the new casing and speaker design of the iPad2. Same modification for the left secondary intake port cover can be utilized on iPad for stability of the audio enhancing apparatus. For more in detail, please refer to FIG. 6.

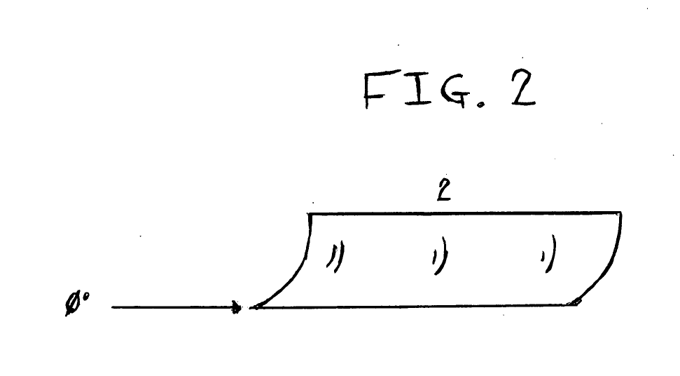

FIG. 2 shows the detailed description of the audio reflector 2. Between 0 to 359 degrees curvature angle can be used. Best optimal curvature angle degree from audio enhancing apparatus' testing was between 10 to 45 degrees in curvature angles of audio reflector 2. Audio reflector do not have to employ curvature surface. It can be flat with no angles but the audio reflector without curvature as whole has to be elevated on the back end to create angles against the outtake port assembly wall 1 and front end of the audio reflector without curvature as a whole has to be at 0 degrees. However, I noticed through the testing that curvature surface audio reflector produced better and smoother audio output. Lastly, for simplicity purpose, present invention does not require to have an audio reflector. Outtake port assembly wall 8a, 8b, 1 can be used for redirecting sound output from the audio enhancing apparatus.

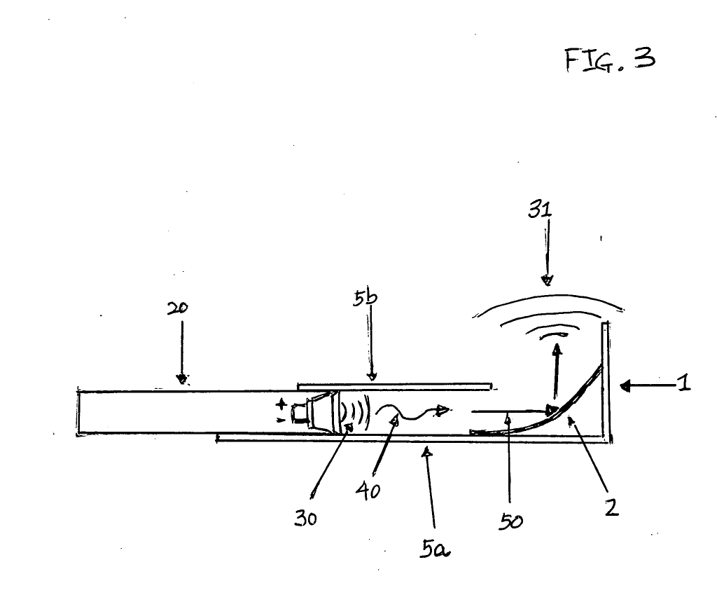

FIG. 3 shows the operational view of the present embodiment from a transparent side view of the audio enhancing apparatus. External audio producing device 20 is attached to the intake port assembly 5a, 5b. The source audio wave generated 30, by the external audio producing device 20. Once source audio output 30 enters between intake port assembly ports 5a, 5b, CAFT process starts 40, creates acoustic reaction. Than the CAFT processed audio 50 is transferred to audio reflector 2. Here, the CAFT processed audio is reflected and redirected 51 upwards and greater enhanced audio output 31 experienced by listener of the external audio producing device 20.

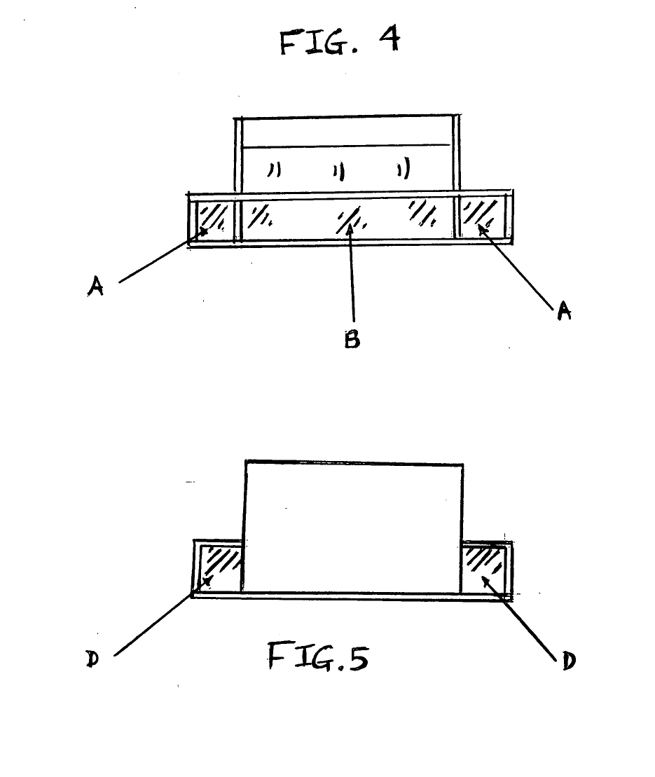

FIG. 4 shows the frontal view of the present invention. The shaded area A, illustrates front secondary intake ports, shaded areas B, illustrates the main audio inceptor port.

FIG. 5 shows the rear view of the present invention. A shaded area D, illustrates, rear secondary exit port.

FIG. 6 shows the perspective view of the present invention with modification for Apple iPad2. Few differences from the general principle concept described above from FIG. 1 through FIG. 5 is the right-secondary intake port external wall 3a.1, which front end is curved to accommodate Apple iPad2's new bottom casing. Additionally, left secondary intake port cover 80, and left-secondary intake port external wall 3b, extends out to the end of the intake port bottom cover 5a, to be used as a latching or fitting mechanism for stability of the present invention. Similar concept can be applied to iPad1 with slight modification to right external wall 3a.1, left secondary audio port cover 80 and secondary intake port external wall 3b.

FIG. 6.1 show the side view of the present invention shows how modified right secondary intake port external wall 3a.1, intake port top cover 5b, and intake port bottom cover 5a would look after present invention has been attached or fitted to Apple iPad2, 90.

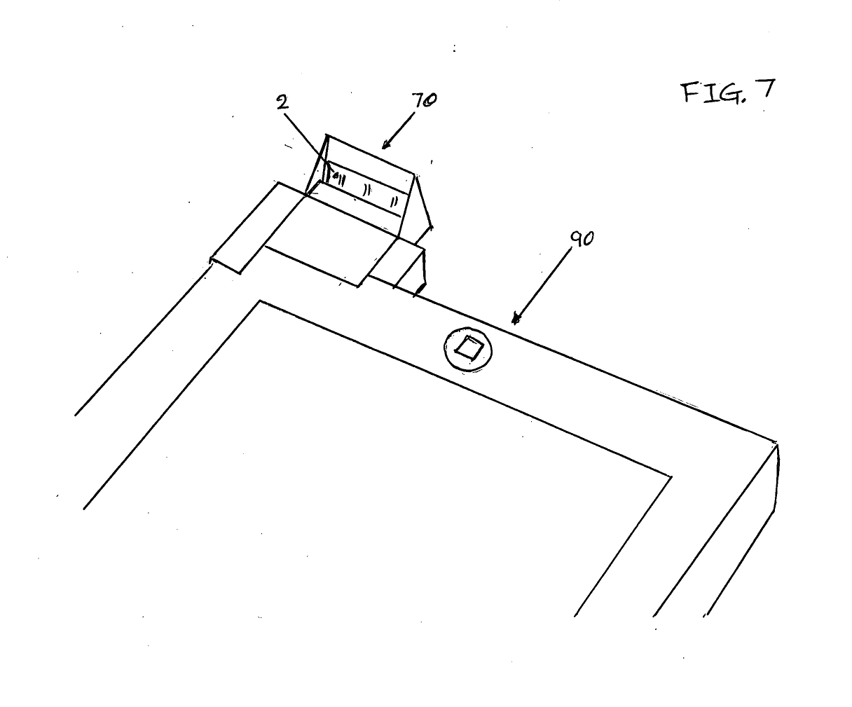

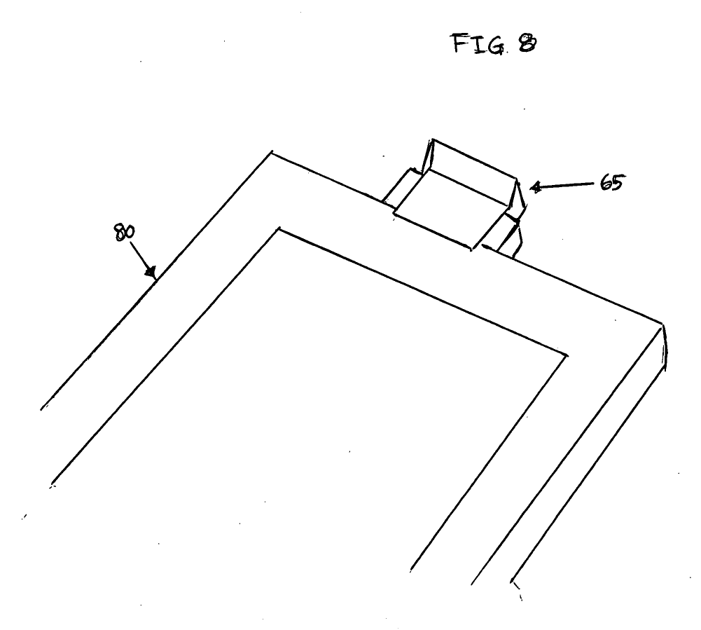

FIG. 7 shows the perspective view of the modified audio enhancing apparatus 70, attached or fitted on to Apple iPad 2, 90. The audio enhancer apparatus on this figure deploys audio reflector, 2 on this figure.

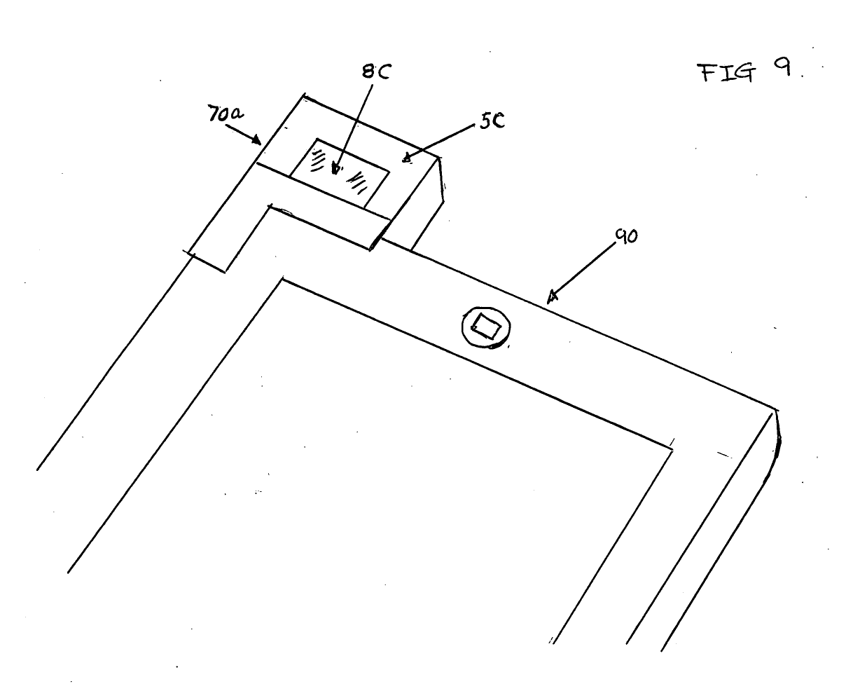

FIG. 8 shows the perspective view of the audio enhancing apparatus 65, attached or fitted to Samsung Galaxy Tablet 80. The audio enhancer apparatus on this figure does not deploy any audio reflector.

FIG. 9 shows the perspective view of the simplified version audio enhancing apparatus 70a attached to the iPad 2, 90. For this simplified audio enhancing apparatus 70a, there is no audio reflector, 2. Intake port top cover 5c has been added. Opened and shaded area, 8c is where audio output will be emitted towards the listener.

Audio decibel test was performed utilizing the present invention apparatus prototype on iPad and iPad 2, using iPad's Sound Effect applications and variety of Youtube video songs. Positive gains on decibel ranges were +8 db to +16 db. Testing procedure was done with the decibel meter on top of the iPad and iPad 2 with decibel meter's microphone faced away from the sound source for unbiased testing.

It should be noted that above-described embodiment are illustrative only, and should not be limiting the present invention to any particular embodiment or group of embodiments. Alternative design such as different geometrical shape and different sizes may be exercised to accommodate current devices in the market and new specification of upcoming similar devices.

What is claimed:

1. Audio enhancer apparatus comprising of flat and/or curved surfaces that is geometrically shaped with opened end or ends.

2. The audio enhancer apparatus of claim 1 wherein internal structure comprising of zero or more audio reflector.

3. The audio enhancer apparatus of claim 1 wherein internal or external structure comprising of any curvature surfaces.

4. The audio enhancer apparatus of claim 1 wherein audio reflector angles are adjustable from 1 to 359 degrees in angles.

5. The audio enhancer apparatus of claim 1 wherein any audio port is opened in any direction.

6. The audio enhancer apparatus of claim 1 wherein intake audio port assembly has one or more internal and external compartmental ports.

7. The audio enhancer apparatus of claim 1 wherein present invention has at least one intake or outtake audio port or both.

8. The audio enhancer apparatus of claim 1 wherein present invention has ability latch, slide, clipped or fitted on the electronic audio producing device with speakers.

9. The audio enhancer apparatus of claim 1 wherein any dimensional parts on the present invention can be increased or decreased depending on the size of the electronic audio producing devices with speakers.

10. The audio enhancer apparatus of claim 1 wherein any or whole parts on the present invention can be constructed in any geometrical shape or forms.

11. The audio enhancer apparatus of claim 1 wherein present invention can be attached and detached from the electronic audio producing devices with speakers.

12. The audio enhancer apparatus of claim 1, wherein the modification and altercation of the design, and size of the present invention to produce different audio output results.

13. The audio enhancer apparatus of claim 1, wherein the use different build materials on the present invention, internally or externally can produce different output audio results.
METHOD CLAIMS

1. A method comprising, manufacturing, processing, assembling of the present invention can be accomplished by utilizing, molding, injection molding, cutting and dye punching.

2. The method of claim 1, wherein build materials on the present invention can be manufactured from using polyurethane, foam, metal, rubber, glass, crystals, ceramic, paper and wood materials.
